(19) United States
(12) Patent Application Publication
(10) Pub. No.: US 2024/0135201 A1
(43) Pub. Date: Apr. 25, 2024

(54) Automated Performative Sequence Generation

(71) Applicant: Disney Enterprises, Inc., Burbank, CA (US)

(72) Inventors: Brianna Butler, Princeton, NJ (US); Komath Naveen Kumar, Los Angeles, CA (US); Alfredo Ayala, West Covina, CA (US)

(21) Appl. No.: 18/098,008

(22) Filed: Jan. 17, 2023

Related U.S. Application Data
(60) Provisional application No. 63/417,901, filed on Oct. 20, 2022.

(51) Int. Cl. G06N 5/022; G06N 7/01

(52) U.S. Cl. CPC G06N 5/022; G06N 7/01

(57) ABSTRACT

A system includes a computing platform having a hardware processor and a memory storing software code and a machine learning (ML) model trained to predict the next element of a sequence. The software code is executed to receive input data identifying an element of the sequence, determine, using the input data, at least one mood driver(s) of the sequence, and predict, based on input data and the mood driver(s), one or more candidate next element(s) of the sequence using the ML model. The software code further obtains expertise data relating to the sequence, evaluates the candidate next element(s), using the expertise data, the input data, and the mood driver(s), to provide aptness score(s) each corresponding to a respective one candidate next element, and determines, using the aptness score(s) and a respective probability assigned to each of the candidate next element(s) by the ML model, the next element of the sequence.

### RELATED APPLICATIONS

The present application claims the benefit of and priority to U.S. Provisional patent application Ser. No. 63/417,901 filed on Oct. 20, 2022, and titled “System and Method to Generate an Adaptive Sequence of States for Controlling a Performance by Incorporating Stylistic Constraints Into a Mixed Data and Knowledge-driven Approach,” which is hereby incorporated fully by reference into the present application.

### BACKGROUND

Advances in artificial intelligence (AI) have enabled the generation of a variety of automated performances, such as those by machines or digital characters that perform actions or simulate social interaction. However, conventionally generated AI performances typically project a single synthesized persona that tends to lack a distinctive personality and is unable to credibly express mood.

In contrast to conventional AI generated performances, actions performed by human beings tend to be more nuanced, varied, and dynamic. For example, speech, movement, facial expressions, and postures of a person are typically influenced by the emotional and physical states of that person. That is to say, typical shortcomings of AI generated performances include their lack of inflection by mood or emotional state such as excitement, disappointment, anxiety, and optimism, to name a few. Thus, there is a need in the art for an automated performative sequence generation solution capable of producing emotionally expressive actions and effects for execution in real-time, dynamically, while a performance is ongoing.

### BRIEF DESCRIPTION OF THE DRAWINGS

FIG. 1 shows an exemplary system for automating performative sequence generation, according to one implementation;

FIG. 2 shows a block diagram of an exemplary software code suitable for use by the system shown in FIG. 1, according to one implementation;

FIG. 3 shows a more detailed diagram of an exemplary mood driver analysis module of the software code shown in FIGS. 1 and 2, according to one implementation;

FIG. 4 shows a flowchart presenting an exemplary method for use by a system to automate performative sequence generation, according to one implementation; and

FIG. 5 shows a flow diagram depicting an exemplary process for automating performative sequence generation, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for automating performative sequence generation. Conventional artificial intelligence (AI) based generative methods typically focus on the fidelity with which a trained machine learning (ML) model can mimic performance states from samples in a dataset based on recordings of human performances. Interpretability of the trained AI model is often sacrificed in the interests of increased accuracy, which makes it difficult to adapt to different styles or modes of performance generation. From the perspective of a user, the ML model is hence usually a black box, which often implies that the ML model can only be adapted by changing the data used to train it. However, collecting data for specific performative styles can be time consuming, and in some cases might additionally require extensive planning to cover all possible conditions expected during generation of the sequence of elements making up a performance, e.g., musical chords, a video sequence, or movements, postures, or facial expressions of a physical or virtual object.

The performative sequence generation solution described herein resolves this issue by operating at a level where human interpretability of the way in which a performative sequence is generated is not sacrificed, allowing a domain or subject matter expert to alter the system behavior in predictable ways. The framework disclosed in the present application includes a Bayesian approach where the knowledge of what mood-driven sequences of elements performed by humans provide a prior akin to what an expert might know from domain specific knowledge, such as music theory in the exemplary use case of generating sequences of musical chords. This prior belief can then be combined with a data-driven system, such as a ML model trained to predict the next element of a sequence, to reconcile with prior beliefs. In addition, the approach disclosed herein can also advantageously be adapted to different types of domains, such as music, animation, and robotics, for example, through the substitution of domain appropriate sequence elements. Moreover, the disclosed performative sequence generation solution can advantageously be implemented as substantially automated systems and methods.

It is noted that, as defined for the purposes of the present application, the terms “automation.” “automated.” and “automating” refer to systems and processes that do not require the participation of a human system administrator. Although in some implementations the performative sequences generated by the systems and methods disclosed herein may be reviewed or even modified by a human editor or system administrator, that human involvement is optional. Thus, the methods described in the present application may be performed under the control of hardware processing components of the disclosed systems.

It is further note that as defined for the purposes of the present application, the term “mood” refers to a transitory emotional state, such as happy, sad, anxious, or angry, to name a few examples. Furthermore, as defined for the purposes of the present application, the expression “mood driver” refers to any characteristic in relation to a system user that may influence the mood of a performance. Examples of mood drivers include an emotional state inferred from an input to the system provided by the system user, an inferred physical state of the system user, a location of the system user, or a feature of an environment of the system user, to name a few.

It is also noted that, as used in the present application, the term “virtual object” may refer to a virtual entity instantiated as a virtual character or feature rendered on a display as part of a two-dimensional (2D) or three-dimensional (3D) animation, and may be or include a digital representation of a person, fictional character, location, inanimate object, and identifier such as a brand or logo, for example, which populates a virtual reality (VR), augmented reality (AR), or mixed reality (MR) environment. Moreover, a virtual environment including such a virtual object may depict virtual worlds that can be experienced by any number of users synchronously and persistently, while providing continuity of data such as personal identity, user history, entitlements, possessions, payments, and the like. It is noted that the concepts disclosed by the present application may also be used to generate a performance by a virtual object, or a physical object, in media that is a hybrid of traditional audio-video (AV) content and fully immersive VR/AR/MR experiences, such as interactive video.

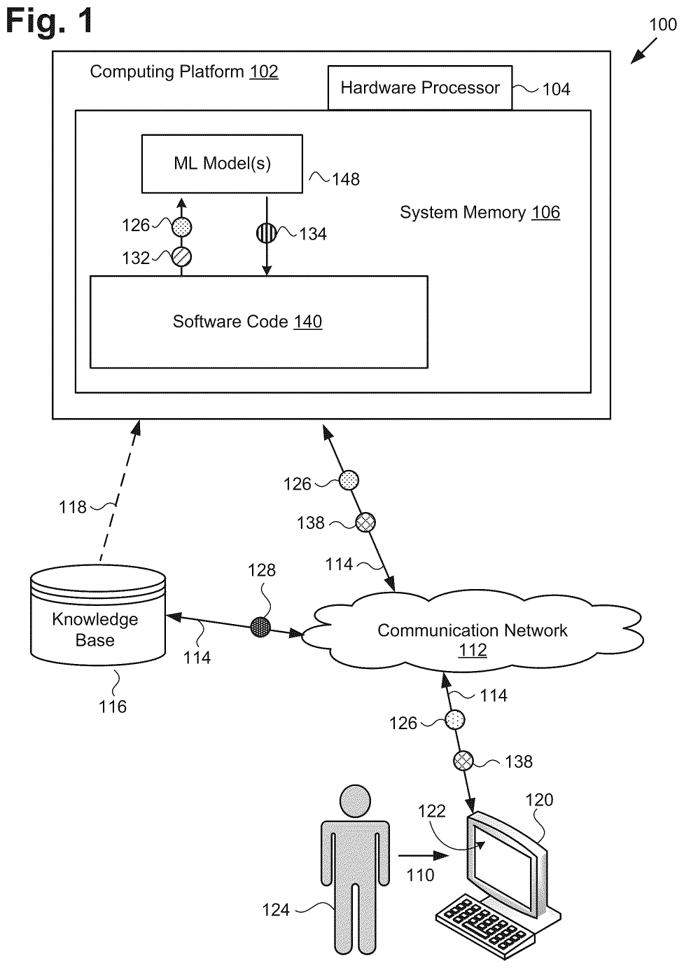

FIG. 1 shows exemplary system 100 for automating performative sequence generation, according to one implementation. As shown in FIG. 1, system 100 includes computing platform 102 having hardware processor 104, and system memory 106 implemented as a computer-readable non-transitory storage medium. According to the present exemplary implementation, system memory 106 stores software code 140 and one or more ML models 148 trained to predict a next element of a sequence (hereinafter “ML model(s) 148”).

It is noted that, as defined for the purposes of the present application, the expression “ML model” refers to a mathematical model for making future predictions based on statistics, or on patterns learned from samples of data or “training data.” Various learning algorithms can be used to map correlations between input data and output data. These correlations form the mathematical model that can be used to make future predictions on new input data. Such a ML model may include one or more logistic regression models. Bayesian models, or ML artificial neural networks (NNs). Moreover, a “deep neural network,” in the context of deep learning, refers to a NN that utilizes multiple hidden layers between input and output layers, which may allow for learning based on features not explicitly defined in raw data. In various implementations. NNs may be trained as classifiers. It is further noted that the expressions “inference” and “prediction” are terms of art in the context of data forecasting, and as used herein have their ordinary and customary meaning known in the art.

As further shown in FIG. 1, system 100 may be implemented in a use environment including knowledge base 116 (hereinafter “KB 116”) providing expertise data 128, communication network 112, and user 124 utilizing client system 120 including display 122. In addition, FIG. 1 shows network communication links 114 communicatively coupling KB 116 and client system 120 with system 100 via communication network 112. Also shown in FIG. 1 is input data 126 and optional weighting factor 138 received by system 100 from client system 120, one or more mood drivers 132 (hereinafter “mood driver(s) 132”) determined by software code 140 using input data 126, and one or more candidate next elements 134 of a sequence (hereinafter “candidate next element(s) 134”) predicted by ML model(s) 148 using input data 126 and mood driver(s) 132.

It is noted that although system 100 may receive expertise data 128 from KB 116 via communication network 112 and network communication links 114, in some implementations. KB 116 may be integrated with computing platform 102 of system 100, or may be in direct communication with system 100, as shown by dashed communication link 118.

Although the present application refers to software code 140 and ML model(s) 148 as being stored in system memory 106 for conceptual clarity, more generally, system memory 106 may take the form of any computer-readable non-transitory storage medium. The expression “computer-readable non-transitory storage medium,” as defined in the present application, refers to any medium, excluding a carrier wave or other transitory signal that provides instructions to hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

It is further noted that although FIG. 1 depicts software code 140 and ML model(s) 148 as being mutually co-located in system memory 106 that representation is also merely provided as an aid to conceptual clarity. More generally, system 100 may include one or more computing platforms, such as computer servers for example, which may be co-located, or may form an interactively linked but distributed system, such as a cloud-based system, for instance. As a result, hardware processor 104 and system memory 106 may correspond to distributed processor and memory resources within system 100. Thus, it is to be understood that software code 140 and ML model(s) 148 may be stored remotely from one another within the distributed memory resources of system 100. It is also noted that, in some implementations, ML model(s) 148 may take the form of one or more software modules included in software code 140.

Hardware processor 104 may include multiple hardware processing units, such as one or more central processing units, one or more graphics processing units, and one or more tensor processing units, one or more field-programmable gate arrays (FPGAs), custom hardware for machine-learning training or, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 140, from system memory 106, while a GPU may be implemented to reduce the processing overhead of the CPU by performing computationally intensive graphics or other processing tasks. A TPU is an application-specific integrated circuit (ASIC) configured specifically for AI applications such as ML modeling.

In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. In addition, or alternatively, in some implementations, system 100 may utilize a local area broadcast method, such as User Datagram Protocol (UDP) or Bluetooth, for instance. Furthermore, in some implementations, system 100 may be implemented virtually, such as in a data center. For example, in some implementations, system 100 may be implemented in software, or as virtual machines. Moreover, in some implementations, communication network 112 may be a high-speed network suitable for high performance computing (HPC), for example a 10 GigE network or an Infiniband network.

Although client system 120 is shown as a desktop computer in FIG. 1, that representation is provided merely as an example as well. More generally, client system 120 may be any suitable mobile or stationary computing device or system that implements data processing capabilities sufficient to provide a user interface, support connections to communication network 112, and implement the functionality ascribed to client system 120 herein. For example, in other implementations, client system 120 and may take the form of a laptop computer, tablet computer, smartphone, or AR or VR device. In still other implementations, client system 120 may be peripheral device of system 100 in the form of a dumb terminal. In those implementations, client system 120 may be controlled by hardware processor 104 of computing platform 102.

With respect to display 122 of client system 120, display 122 may be physically integrated with client system 120, or may be communicatively coupled to but physically separate from client system 120. For example, where client system 120 is implemented as a smartphone, laptop computer, or tablet computer, display 122 will typically be integrated with client system 120. By contrast, where client system 120 is implemented as a desktop computer, display 122 may take the form of a monitor separate from client system 120 in the form of a computer tower. Furthermore, display 122 of client system 120 may be implemented as a liquid crystal display (LCD), a light-emitting diode (LED) display, an organic light-emitting diode (OLED) display, a quantum dot (QD) display, or any other suitable display screen that performs a physical transformation of signals to light.

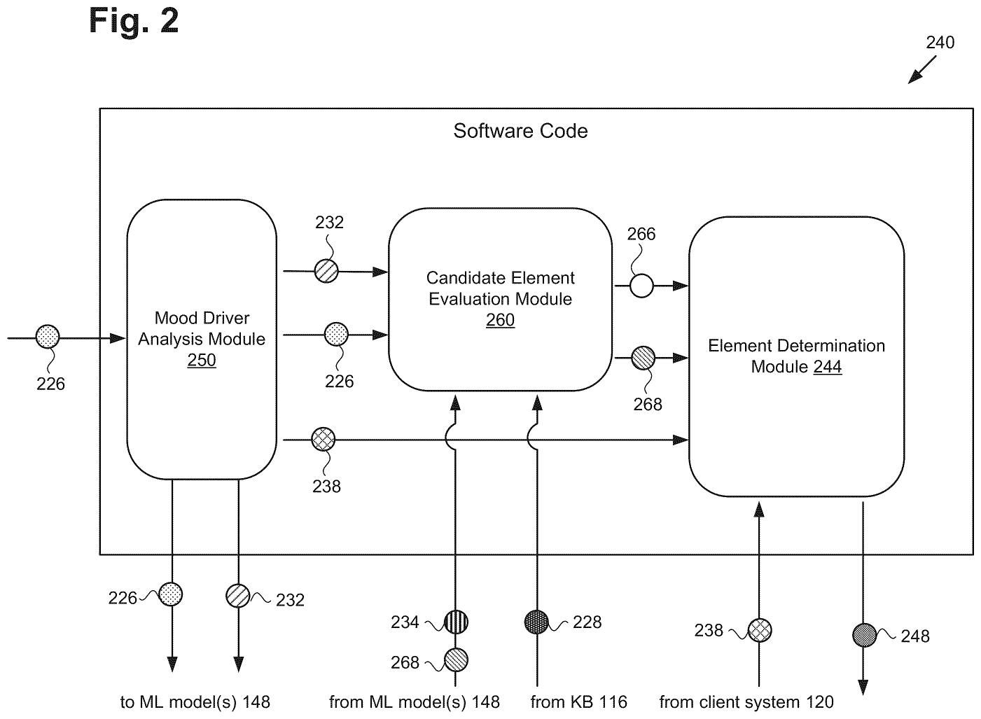

FIG. 2 shows a diagram of exemplary software code 240 suitable for use by system 100, in FIG. 1, according to one implementation. As shown in FIG. 2, software code 240 includes mood driver analysis module 250, candidate element evaluation module 260, and element determination module 244. As further shown in FIG. 2, software code 240 receives input data 226 identifying an element of a sequence, as an input, provides input data 226 and mood driver(s) 232 as outputs to ML model(s) 148 in FIG. 1, receives candidate next element(s) 234, expertise data 228, and optional weighting factor 238 as inputs from ML model(s) 148. KB 116, and client system 120, respectively, and determines next element 248 of the sequence. Also shown in FIG. 2 are one or more aptness scores 266 (hereinafter “aptness score(s) 266”) corresponding respectively to candidate next element(s) 234, and one or more probabilities 268 each assigned to a respective one of candidate next element(s) 234 by ML models) 148.

It is noted that, in some implementations weighting factor 238 may be included in input data 226. In those implementations, as shown in FIG. 2, weighting factor 238 may be extracted from input data 226 by mood driver analysis module 250, and may be received by element determination module 244 from mood driver analysis module 250 rather than from client system 220.

Software code 240, input data 226, expertise data 228, mood driver(s) 232, candidate next element(s) 234, and weighting factor 238 correspond respectively in general to software code 140, input data 126, expertise data 128, mood driver(s) 132, candidate next element(s) 134, and weighting factor 138, in FIG. 1. Consequently, software code 140, input data 126, expertise data 128, mood driver(s) 132, candidate next element(s) 134, and weighting factor 138 may share any of the characteristics attributed to respective software code 240, input data 226, expertise data 228, mood driver(s) 232, candidate next element(s) 234, and weighting factor 238 by the present disclosure, and vice versa. That is to say, like software code 240, software code 140 may include features corresponding respectively to mood driver analysis module 250, candidate element evaluation module 260, and element determination module 244. Moreover, like software code 140, in some implementations, software code 240 may further include ML model(s) 148.

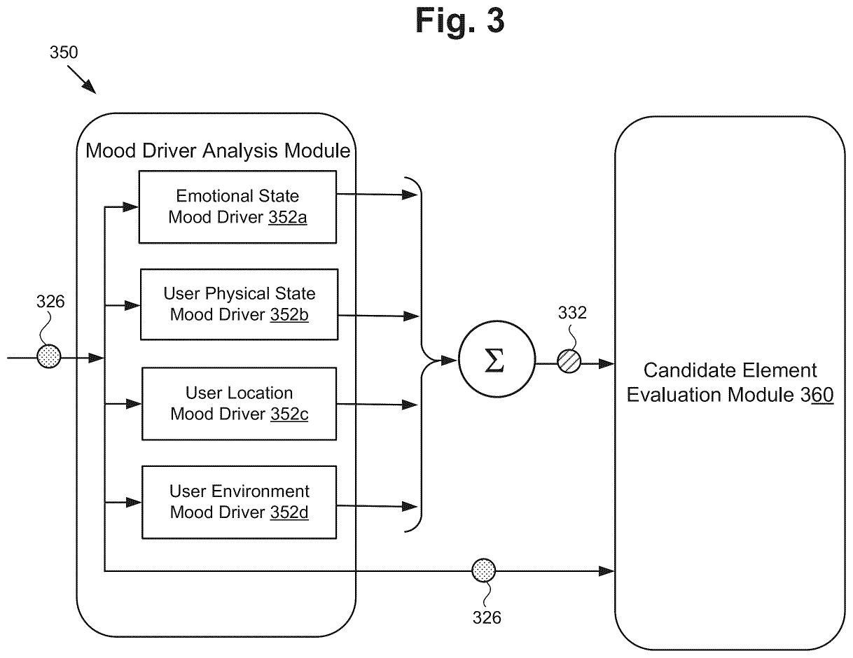

FIG. 3 shows a more detailed diagram of an exemplary mood driver analysis module of software code 140/240 in FIGS. 1 and 2, according to one implementation. As shown in FIG. 3, mood driver analysis module 350 may be configured to identify mood driver(s) 332 using input data 326 at several different levels of analysis. According to the exemplary implementation shown in FIG. 3, for instance, mood driver analysis module 350 may include one or more of emotional state mood driver block 352a, user physical state mood driver block 352b, user location mood driver block 352c, and user environment mood driver block 352d, each of which, in some implementations as also shown in FIG. 3, may process input data 326 in parallel, i.e., contemporaneously with one another.

In addition to input data 326 and mood driver analysis module 350. FIG. 3 shows mood driver(s) 332 determined by mood driver analysis module 350 as a combination of the outputs of whichever of emotional state mood driver block 352a, user physical state mood driver block 352b, user location mood driver block 352c, and user environment mood driver block 352d are included in mood driver analysis module 350, and provided as an output to candidate element evaluation module 360 along with input data 326.

It is noted that input data 326 and mood driver(s) 332 correspond respectively in general to input data 126/226 and mood driver(s) 132/232, in FIGS. 1 and 2. Consequently, input data 326 and mood driver(s) 332 may share any of the characteristics attributed to respective input data 126/226 and mood driver(s) 132/232 by the present disclosure, and vice versa. Moreover, mood driver analysis module 350 and candidate element evaluation module 360 correspond respectively in general to mood driver analysis module 250 and candidate element evaluation module 260, in FIG. 2. Thus, mood driver analysis module 350 and candidate element evaluation module 360 may share any of the characteristics attributed to respective mood driver analysis module 250 and candidate element evaluation module 260 by the present disclosure, and vice versa. Thus, like mood driver analysis module 350, mood driver analysis module 250 may include features corresponding respectively to one or more of emotional state mood driver block 352a, user physical state mood driver block 352b, user location mood driver block 352c, and user environment mood driver block 352d.

Emotional state mood driver block 352a may be configured to determine a mood driver based on a mood corresponding to the sequence element identified by input data 126/226/326 received from client system 120. By way of example, in use cases in which the sequence element identified by input data 126/226/326 is a musical chord, emotional state mood driver block 352a may identify a mood driver as being one of melancholy or optimistic dependent upon whether the musical chord identified by input data 126/226/326 is a minor scale chord or a major scale chord, respectively.

User physical state mood driver block 352b may be configured to determine a mood driver based on a mood corresponding to a physical state of user 124 inferred from input data 126/226/326. For example, in use cases in which input data 126/226/326 is received as audio data corresponding to a voice command by user 124, a physical state of user 124, such as fatigue or excitement for instance, may be inferred from the tone of voice or forcefulness of speech of user 124. Alternatively, in use cases in which input data 126/226/326 includes one or more images of user 124, the physical state of use 124 may be inferred from a posture, gesture, or facial expression of user 124 captured by the one or more images.

User location mood driver block 352c may be configured to determine a mood driver based on a geographical location of user 124. For example, input data 126/226/326 may include Global Positioning System (GPS) data, radio-frequency identification (RFID) data, or other beacon data identifying the location of user 124.

User environment mood driver block 352d may be configured to determine a mood driver based on the surroundings of user 124. For example, input data 126/226/326 may include audio data or imagery captured by one or more sensors of client system 120. As a specific example, in use cases in which user 124 is part of an audience or crowd, audience or crowd noise, or background noise from the venue occupied by user 124 may be analyzed to determine a mood driver. It is noted that, in various implementations, the combination of the outputs of emotional state mood driver block 352a, user physical state mood driver block 352b, user location mood driver block 352c, and user environment mood driver block 352d resulting in determination of mood driver(s) 132/232/332 may be additive, multiplicative, or some other function of those outputs.

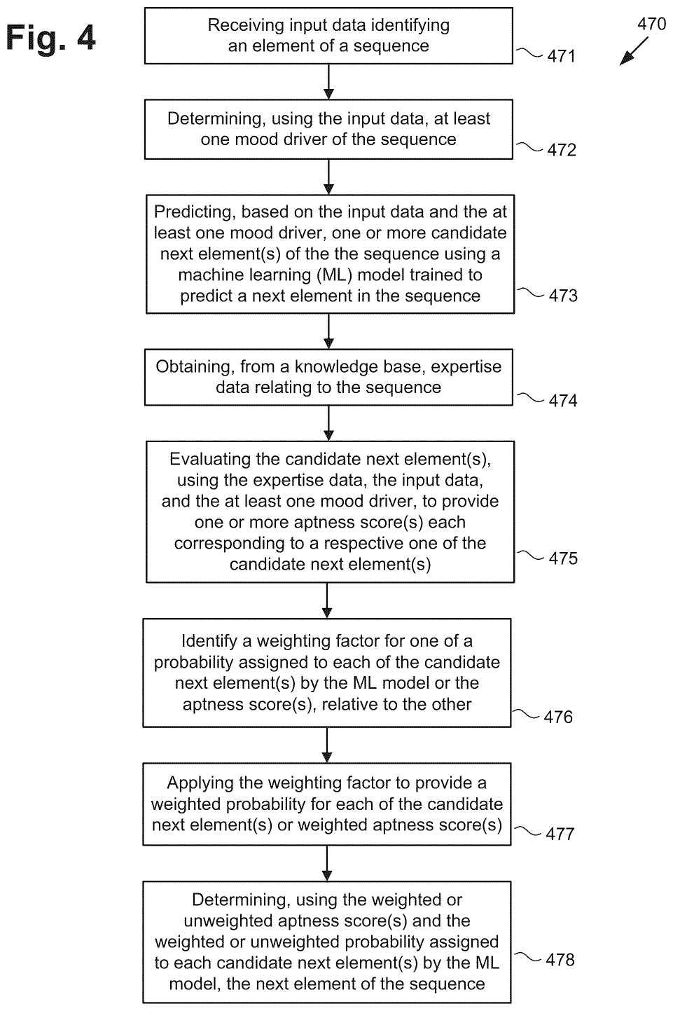

The functionality of software code 140/240 will be further described by reference to FIG. 4. FIG. 4 shows flowchart 470 presenting an exemplary method for use by a system, such as system 100, to automate performative sequence generation, according to one implementation. With respect to the method outlined in FIG. 4, it is noted that certain details and features have been left out of flowchart 470 in order not to obscure the discussion of the inventive features in the present application.

Referring to FIG. 4, with further reference to FIGS. 1, 2, and 3, flowchart 470 includes receiving input data 126/226/326 identifying an element of a sequence (action 471). Input data 126/226/326 may include a variety of different types of data. For example, input data 126/226/326 may include a text input to client system 120 by user 124, audio data of a voice input to client system 120, or both. In addition, in some implementations, input data 126/226/326 may include camera data including one or more images of user 124, the environment of user 124, or both. Also in in addition, in some implementations input data 126/226/326 may include sensor data, such as GPS data, RFID data, or other beacon data identifying a location of user 124. That is to say, in various use cases input data 126/226/326 may be or include data corresponding to an affirmative selection by user 124 (i.e., “user data”), may be or include data generated by one or more or cameras or sensors (i.e., “control data”), or may include user data as well as control data.

The element of the sequence identified by input data 126/226/326 may also assume a variety of different forms. By way of example, in some implementations the sequence may be a performance, such as the playing of a musical chord progression for instance, and the element of the sequence identified by input data 126/226/326 may be a single musical chord, either starting the chord progression sequence, or being an intermediate musical chord of the chord progression sequence, such as one marking a musical transition within the sequence. Alternatively, in some implementations, the sequence may include one or more of movements, postures, or facial expressions of a physical object, such as a robot, or a virtual object, and the element of the sequence identified by input data 126/226/326 may be one such movement, posture of facial expression. As yet another alternative, the sequence may take the form of a video sequence, and the element of the sequence identified by input data 126/226/326 may be a video frame, either the first frame of the video sequence or an intermediate frame.

Input data 126/226/326 may be received in action 471 by mood driver analysis module 250/350 of software code 140/240, executed by hardware processor 104 of system 100. For example, as shown in FIG. 1, input data 126/226/326 may be received by system 100 from client system 120, via communication network 112 and network communication links 114.

Continuing to refer to FIG. 4 in combination with FIGS. 1, 2, and 3, the method outlined by flowchart 470 further includes determining, using input data 126/226/326, at least one mood driver 132/232/332 of the sequence (action 472). Action 472 may be performed by software code 140/240, executed by hardware processor 104 of system 100, using mood driver analysis module 250/350, as described above by reference to FIG. 3. For example, and as stated above, mood driver(s) 132/232/332 may be determined using several different levels of analysis performed using one or more of emotional state mood driver block 352a, user physical state mood driver block 352b, user location mood driver block 352c, and user environment mood driver block 352d, some or all of which may process input data 126/226/326 in parallel, i.e., contemporaneously with one another.

Continuing to refer to FIG. 4 in combination with FIGS. 1, 2, and 3, the method outlined by flowchart 470 further includes predicting, based on input data 126/226/326 and mood driver(s) 132/232/332, one or more candidate next elements 134/234 of the sequence using ML model(s) 148 (action 473). It is noted that ML model(s) 148 may include multiple ML models each specifically trained to predict candidate next element(s) 134/234 of a different type of sequence. That is to say, for example, ML model(s) 148 may include a first ML model trained to predict the next musical chord of a chord progression, a second ML model trained to predict the movement by a physical or virtual object, a third ML model trained to predict the next posture assumed by the physical or virtual object, and so forth.

In addition to predicting candidate next element(s) 134/234. ML model(s) may be configured to assign one of one or more probabilities 268 to each of candidate next element(s) 134/234 in action 473. Each of one or more probabilities 268 may be expressed as a percentage, for example, reflecting a level of confidence that a particular one of candidate next element(s) 134/234 should be the next element of the sequence, such that a probability of 100% expresses certainty, while any probability greater than 50% indicates that the candidate next element is more likely than not next element 248 of the sequence. Predicting one or more candidate next elements 134/234 of the sequence, and assigning one of one or more probabilities 268 to each of candidate next element(s) 134/234, in action 473, may be performed by software code 140/240, executed by hardware processor 104 of system 100, and using ML model(s) 148.

Referring to FIG. 4 in combination with FIGS. 1 and 2, the method outlined by flowchart 470 further includes obtaining, from KB 116, expertise data 128/228 relating to the sequence (action 474). Expertise data 128/228 may vary based on the nature of the sequence including the element identified by input data 126/226/326. For example, where the sequence is a progression of musical chords, expertise data 128/228 may include music theory data. By contrast, where the sequence is a succession of movements, expertise data 128/228 may include choreography data, anatomical data, or both. As yet another example, where the sequence is a video sequence, expertise data 128/228 may include video editing data. Action 474 may be performed by candidate element evaluation module 260 of software code 140/240, executed by hardware processor 104 of system 100.

Referring to FIG. 4 in combination with FIGS. 1, 2, and 3, the method outlined by flowchart 470 further includes evaluating one or more candidate next element(s) 134/234, using expertise data 128/228, input data 126/226/326, and mood driver(s) 132/232/332, to provide one or more aptness scores 266 each corresponding to a respective one of candidate next element(s) 134/234 (action 475). It is noted that while the prediction performed using ML model(s) 148 in action 473 is a data-driven process influenced in part by mood driver(s) 132/232/332, the evaluation performed in action 475 is knowledge-driven based on expertise data 128/228, as well as mood-driven based on mood driver(s) 132/232/332. It is further noted that aptness score(s) 266 may be independent of one or more probabilities 268 and provide a measure of the consistency and coherence of each of candidate next element(s) 134/234 in relation to the element identified by input data 126/226/326 and other sequence elements preceding candidate next element(s) 134/234, as well as in relation to mood driver(s) 132/232/332. That is to say, candidate next element(s) 134/234 is the data science answer to the question “what element comes next,” while aptness score(s) provide expert knowledge and mood based answers to the question “is that candidate next element an appropriate choice.” The evaluation of candidate next element(s) 134/234 in action 475 may be performed by candidate element evaluation module 260 of software code 140/240, executed by hardware processor 104 of system 100.

Referring to FIG. 4 in combination with FIGS. 1, 2, and 3, in some implementations the method outlined by flowchart 470 may further include, identifying weighting factor 138/238 for one of the probability 268 assigned to each of candidate next element(s) 134/234 by ML model(s) 148 or for aptness score(s) 266, relative to the other of the probability 268 assigned to each of candidate next element(s) 134/234 by ML model(s) 148 or aptness score(s) 266 (action 476). It is noted that, in some implementations, weighting factor 138/238 may be user selected and may be received from client system 120, while in other implementations weighting factor 138/238 may be generated dynamically by software code 140/240. It is further noted that action 476 is optional, and in some implementations, the method outlined by flowchart 470 may omit action 476. However, in implementations in which the method outlined by flowchart 470 includes action 476, action 476 may be performed by element determination module 244 of software code 140/240, executed by hardware processor 104 of system 100.

In the absence of weighting factor 138/238, each of aptness score(s) 266 and the probability 268 assigned to each of candidate next element(s) 134/234 by ML model(s) 148 may be “unweighted” and thereby carry equal weight in the ultimate determination as to which of candidate next element(s) 134/234 is to be next element 248 of the sequence. However, in various use cases, user 124 may wish to preferentially weight one of aptness score(s) 266 or the probability 268 assigned to each of candidate next element(s) 134/234 by ML model(s) 148 thereby making the determination of next element 248 more, or less, expert knowledge and mood-driven based relative to data-driven based.

In some implementations, weighting factor 138/238 may be received by system 100 independently of input data 126/226/326. In those implementations, weighting factor 138/238 may be received by element determination module 244 from client system 120, via communication network 112 and network communication links 114. However, in other implementations, weighting factor 238 may be included in input data 126/226/326, may be extracted from input data 126/226/326 by mood driver analysis module 250, and may be received by element determination module 244 from mood driver analysis module 250. Moreover, it is noted that although flowchart 470 lists optional action 476 as following action 475, that representation is merely exemplary, in various implementations in which action 476 is performed as part of the method outlined by flowchart 470, action 476 may precede any of actions 472, 473, 474, or 475. In addition, or alternatively, in implementations in which action 476 is performed, action 476 may be performed in parallel with, i.e., contemporaneously with, one or more of actions 471, 472, 473, 474, or 475.

Referring to FIG. 4 in combination with FIGS. 1 and 2, in implementations in which action 476 is performed, flowchart 470 further includes applying weighting factor 238 to provide one of a weighted probability 268 for each of the one or more candidate next elements or weighted aptness score(s) 266 (action 477). When included in the method outlined by flowchart 470, action 477 may be performed by element determination module 244 of software code 140/240, executed by hardware processor 104 of system 100.

Continuing to refer to FIG. 4 in combination with FIGS. 1 and 2 flowchart 470 further includes determining, using the weighted or unweighted aptness scores 266 and the weighted or unweighted respective probability 268 assigned to each of candidate next elements 134/234 by ML model(s), next element 248 of the sequence (action 478). That is to say, in implementations in which actions 476 and 477 are omitted from the method outlined by flowchart 470, the determination performed in action 478 uses unweighted aptness scores 266 and unweighted one or more probabilities 268. In those implementations, for example, next element 248 may be determined to be the one of candidate next element(s) 134/234 having the highest combined, e.g., summed, aptness score and probability.

However, in implementations in which actions 476 and 477 are performed, the determination performed in action 478 may use weighted aptness score(s) 266 and unweighted one or more probabilities 268, or unweighted aptness score(s) 266 and one or more weighted probabilities 268. In those implementations, for example, next element 248 may be determined to be the one of candidate next element(s) 134/234 having the highest combined, e.g., summed, weighted aptness score and unweighted probability, or unweighted aptness score and weighted probability. The determination of next element 248 of the sequence in action 478 may be performed by element determination module 244 of software code 140/240, executed by hardware processor 104 of system 100.

Referring to FIGS. 1, 2, and 3, as noted above, in some implementations the sequence including the element identified by input data 126/226/326 may include a performance. In those implementations, next element 248 may be one of a continuation of the performance or a conclusion to the performance. In some implementations, as also noted above, the sequence may include a progression of musical chords, in which use case next element 248 too may be a musical chord. Moreover, in implementations in which the sequence includes one or more of movements, postures, or facial expressions of a physical or virtual object, next element 248 may be a movement, posture, or facial expression of such an object. It is further noted that in implementations in which the sequence is or includes a video sequence, next element 248 may be one or more video frames.

In some implementations, the method outlined by flowchart 470 may conclude with action 478 described above, as shown in FIG. 4. However, in other implementations, and as shown in FIG. 2 with further reference to FIG. 1, hardware processor 104 of system 100 may further execute software code to output next element 248 for use by user 124. In some implementations next element 248 may be output by being transmitted to client system 120 via communication network 112 and network communication links 114.

Alternatively, or in addition, and as also noted above, in some implementations client system 120 may be a peripheral dumb terminal of system 100, under the control of hardware processor 104 of system 100. In those implementations, system 100 may control client system 120 to render next element 248 on display 122 of client system 120 or using an audio output device of client system 120.

With respect to the method outlined by flowchart 470, it is emphasized that actions 471, 472, 473, 474, and 475 (hereinafter “actions 471-475”) and action 478, or actions 471-475, 476, 477, and 478, may be performed in an automated process from which human involvement may be omitted.

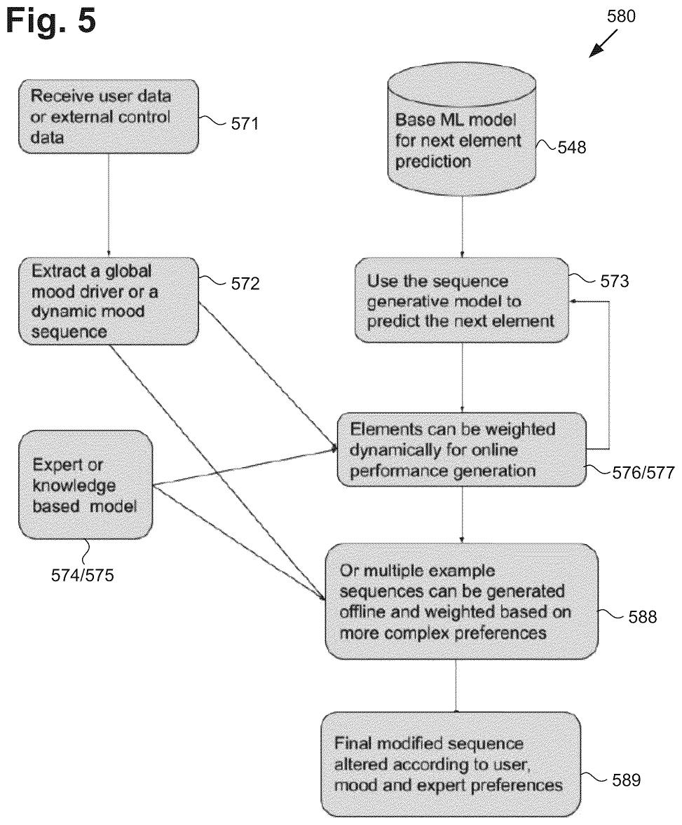

FIG. 5 shows flow diagram 580 depicting an exemplary process for automating performative sequence generation, according to one implementation. Flow diagram 580 incorporates the actions described above by reference to flowchart 470, but extends those actions to produce a complete sequence, rather than merely determining a next element of the sequence. It is noted that actions 571, 572, 573, 574/575, and 576/577 of flow diagram 580 correspond respectively in general to actions 471, 472, 473, 474 and 475, and 476 and 477 of flowchart 470, while base ML model 548 used in action 573 corresponds in general to ML model(s) 148 in FIG. 1. Consequently, actions 571, 572, 573, 574/575, and 576/577 may share any of the characteristics attributed to actions 471, 472, 473, 474 and 475, and 476 and 477 by the present disclosure, and vice versa, while base ML model 548 and ML model(s) 148 may share any of the characteristics attributed to either feature herein.

As shown by action 576/577 of flow diagram 580, in some use cases the weighting factors may be identified dynamically, and may be utilized in a feedback loop to influence action 573. Alternatively, in other use cases actions 471, 472, 473, 474, 475, and 478 of flowchart 470 may be followed by additional iterations of actions 473, 475, and 478 until the desired sequence is completed and weighted in action 588. In some of those use cases, the completed sequence may be modified according to the mood of the user and expertise data in action 589.

As noted above, in some exemplary use cases, the method outlined by flowchart 470 may be applied to automated music performance. For example, while a song may be thought of as comprising sections such as chorus, pre-chorus, verse, instrumental, each with unique musical purposes in how they convey the song to the listener, at a finer structure, most musical compositions are based on transitioning between harmonic structures referred to as chords (herein also referred to as “musical chords”). A song can then be viewed as being generated by hierarchical state machines, where a specific sequence of states controls how the music is perceived. Expertise data from academic music theory can inform what chord transitions are considered to be optimal. However, because it is often the variation from preset rules that adds flair to a musical composition, the approach disclosed in the present application utilizes one or more mood drivers, in addition to music theory priors, to influence the selection and sequencing of the musical chords included in a performance.

The data aspect of the present automated performative sequence generation approach is driven by user selected chord progression training data from their choice of source. The training data enables a trained ML model to predict probabilities for specific sequences of chords appearing within a performance. This aspect of the systems allows users to alter the chord progressions generated by pulling data-driven progressions from their own favorite songs, allowing the system to generate progressions more familiar to their own ear. The ML model will put together chords likely to follow each other in a sequence. However, as many previous attempts to implement purely data-driven solutions have shown, these progressions do not always sound cohesive. Thus, according to the present novel and inventive concepts, mood inspired chord progression data drives the chord generation while expertise data in the form of music theory can act as an aptness checker for the chords, i.e., music theory provides a guideline as to what chords actually sound good together and when.

For the music theory aspect of the present automated performative sequence generation approach, a ruleset for the chords may be manually produced, based on rules in music theory, such as Roman numeral analysis, for example. The ruleset gives each progression generated its own music theory aptness score based on how “cohesive” it seems according to music theory. Music theory also plays a part in the role of how a mood driver will shape the chords generated according to the present solution. It is noted that many aspects of music theory are inherently associated with how music makes a listener feel. For example, and as alluded to above minor scales are commonly used in sadder musical pieces and major scales are common in happier ones.

In addition to musical chord progressions, the performative sequence generation solution disclosed herein can be generalized and applied to other interactive implementations. For example, the present solution may be used to interactively assist artists in the creation of sequence based music or visual performances, by helping with competition or scoring over different possible sequencing options.

In addition, the automated performative sequence generation solution disclosed herein can be generalized and applied to other sequence-based tasks. One such sequence-based task is animation of a virtual character or robot. That type of animation, like music, operates on a series of states transitioning to one another and has a defined set of rules commonly used to improve the quality of the animation. According to the present novel and inventive concepts, the mood driver inflects the actions of the character to express a particular emotional or physical state that helps bring personality to the character or robot.

This mood-driven application of the present automated performative sequence generation solution to character or robotic animation enables the synthesis of primary movements or “macro-movements” by the character or robot with micro-movements that produce the illusion of thought and intentional transition from one physical posture, position, or expression to another in a meaningful way that lends verisimilitude to the action. In essence the present solution advantageously enables the introduction of spontaneity into character or robotic motion analogous to the spontaneity expressed by a human musician when riffing during a jazz performance.

Thus, the present application discloses systems and methods for automating performative sequence generation. The performative sequence generation solution described herein advances the state-of-the art by disclosing an AI inspired hybrid data-driven and knowledge-driven approach in which human interpretability of the way in which a performative sequence is generated is not sacrificed, thereby advantageously allowing a domain or subject matter expert to alter the system behavior in predictable ways. In addition, the approach disclosed herein can also advantageously be adapted to different types of domains, such as music, animation, and robotics, for example, through the substitution of domain appropriate sequence elements. Moreover, the disclosed performative sequence generation solution can further advantageously be implemented as substantially automated systems and methods.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform having a hardware processor and a system memory storing a software code and a machine learning (ML) model trained to predict a next element of a sequence;
the hardware processor configured to execute the software code to:
receive input data identifying an element of the sequence;
determine, using the input data, at least one mood driver of the sequence;
predict, based on the input data and the at least one mood driver, one or more candidate next elements of the sequence using the ML model;
obtain, from a knowledge base, expertise data relating to the sequence;
evaluate the one or more candidate next elements, using the expertise data, the input data, and the at least one mood driver, to provide one or more aptness scores each corresponding to a respective one of the one or more candidate next elements; and
determine, using the one or more aptness scores and a respective probability assigned to each of the one or more candidate next elements by the ML model, the next element of the sequence.

2. The system of claim 1, wherein the sequence comprises a performance and the next element of the sequence is one of a continuation of the performance or a conclusion to the performance.

3. The system of claim 1, wherein the sequence and the next element of the sequence comprise at least one of musical chords or one or more of movements, postures, or facial expressions of a physical or virtual object.

4. The system of claim 1, wherein the sequence comprises a video sequence, and the next element of the sequence comprises at least one video frame.

5. The system of claim 1, wherein the at least one mood driver of the sequence comprises an emotional state determined using the element identified by the input data.

6. The system of claim 1, wherein the at least one mood driver of the sequence comprises at least one of a physical state of a user inferred from the input data, a location of the user, or a feature of an environment of the user.

7. The system of claim 1, wherein the hardware processor is further configured to execute the software code to:
identify, a weighting factor for one of the probability assigned to each of the one or more candidate next elements by the ML model or the one or more aptness scores, relative to the other of the probability assigned to each of the one or more candidate next elements or the one or more aptness scores; and
apply the weighting factor to provide one of a weighted probability for each of the one or more candidate next elements or weighted one or more aptness scores;
wherein determining the next element of the sequence uses the one of the weighted probability for each of the one or more candidate next elements or the weighted one or more aptness scores.

8. A method for use by a system including a computing platform having a hardware processor and a system memory storing a software code and a machine learning (ML) model trained to predict a next element of a sequence, the method comprising:
receiving, by the software code executed by the hardware processor, input data identifying an element of the sequence;
determining, by the software code executed by the hardware processor and using the input data, at least one mood driver of the sequence;
predicting, based on the input data and the at least one mood driver, one or more candidate next elements of the sequence, by the software code executed by the hardware processor and using the ML model;
obtaining, by the software code executed by the hardware processor, from a knowledge base, expertise data relating to the sequence;
evaluating, by the software code executed by the hardware processor, the one or more candidate next elements, using the expertise data, the input data, and the at least one mood driver, to provide one or more aptness scores each corresponding to a respective one of the one or more candidate next elements; and
determining, by the software code executed by the hardware processor and using the one or more aptness scores and a respective probability assigned to each of the one or more candidate next elements by the ML model, the next element of the sequence.

9. The method of claim 8, wherein the sequence comprises a performance and the next element of the sequence is one of a continuation of the performance or a conclusion to the performance.

10. The method of claim 8, wherein the sequence and the next element of the sequence comprise at least one of musical chords or one or more of movements, postures, or facial expressions of a physical or virtual object.

11. The method of claim 8, wherein the sequence comprises a video sequence, and the next element of the sequence comprises at least one video frame.

12. The method of claim 8, wherein the at least one mood driver of the sequence comprises an emotional state determined using the element identified by the input data.

13. The method of claim 8, wherein the at least one mood driver of the sequence comprises at least one of a physical state of a user inferred from the input data, a location of the user, or a feature of an environment of the user.

14. The method of claim 8, further comprising:
identifying, by the software code executed by the hardware processor, a weighting factor for one of the probability assigned to each of the one or more candidate next elements by the ML model or the one or more aptness scores, relative to the other of the probability assigned to each of the one or more candidate next elements or the one or more aptness scores; and
applying, by the software code executed by the hardware processor, the weighting factor to provide one of a weighted probability for each of the one or more candidate next elements or weighted one or more aptness scores;
wherein determining the next element of the sequence uses the one of the weighted probability for each of the one or more candidate next elements or the weighted one or more aptness scores.

15. A computer-readable non-transitory storage medium having stored thereon a software code, which when executed by a hardware processor, instantiates a method comprising:
receiving input data identifying an element of a sequence;
determining, using the input data, at least one mood driver of the sequence;
predicting, based on the input data and the at least one mood driver, one or more candidate next elements of the sequence using a machine learning (ML) model trained to predict a next element of the sequence;
obtaining, from a knowledge base, expertise data relating to the sequence;
evaluating the one or more candidate next elements, using the expertise data, the input data, and the at least one mood driver, to provide one or more aptness scores each corresponding to a respective one of the one or more candidate next elements; and
determining, using the one or more aptness scores and a respective probability assigned to each of the one or more candidate next elements by the ML model, the next element of the sequence.

16. The computer-readable non-transitory storage medium of claim 15, wherein the sequence comprises a performance and the next element of the sequence is one of a continuation of the performance or a conclusion to the performance.

17. The computer-readable non-transitory storage medium of claim 15, wherein the sequence and the next element of the sequence comprise at least one of musical chords or one or more of movements, postures, or facial expressions of a physical or virtual object.

18. The computer-readable non-transitory storage medium of claim 15, wherein the sequence comprises a video sequence, and the next element of the sequence comprises at least one video frame.

19. The computer-readable non-transitory storage medium of claim 15, wherein the at least one mood driver of the sequence comprises one or more of an emotional state determined using the element identified by the input data, a physical state of a user inferred from the input data, a location of the user, or a feature of an environment of the user.

20. The computer-readable non-transitory storage medium of claim 15, wherein the method further comprises:
identifying a weighting factor for one of the probability assigned to each of the one or more candidate next elements by the ML model or the one or more aptness scores, relative to the other of the probability assigned to each of the one or more candidate next elements or the one or more aptness scores; and
applying the weighting factor to provide one of a weighted probability for each of the one or more candidate next elements or weighted one or more aptness scores;
wherein determining the next element of the sequence uses the one of the weighted probability for each of the one or more candidate next elements or the weighted one or more aptness scores.
